(19) United States
(12) Patent Application Publication
(10) Pub. No.: US 2015/0147465 A1
(43) Pub. Date: May 28, 2015

(54) Non-Tracking Tack Coat

(71) Applicant: Russell Standard Corporation, Pittsburgh, PA (US)

(72) Inventors: Matthew Shaffer, Spring Grove, PA (US); Logan Norman, Arden, NC (US)

(21) Appl. No.: 14/550,221

(22) Filed: Nov. 21, 2014

Related U.S. Application Data
(60) Provisional application No. 61/907,535, filed on Nov. 22, 2013.

(51) Int. Cl. C09D 195/00; E01C 7/00

(52) U.S. Cl. CPC C09D 195/005; E01C 7/00
USPC 427/138; 524/60

(57) ABSTRACT

Provided herein is a tack coat for use with paving applications and a method of making the same. The tack coat is substantially non-tracking, and includes asphalt, a pH adjustor, an emulsifier, acrylic, and water. In certain embodiments, the tack coat may also include a stabilizer to prevent settling of the emulsion during storage. The method of producing the tack coat involves heating the asphalt in one tank, and heating the water and emulsifier in a second, separate tank. This mixture of the water and emulsifier is referred to as soap, and is then mixed with asphalt, and the acrylic may be added to the mixture immediately thereafter, with a stabilizer, or later, just prior to shipment of the product, in which case a stabilizer may not be required. The tack coat exhibits moderate softness, with a penetration value above 40 dmm.

### CROSS-REFERENCE TO RELATED APPLICATIONS

The present application claims the benefit of U.S. Provisional Patent Application No. 61/907,535, filed Nov. 22, 2013, the disclosure of which is incorporated herein by reference in its entirety.

### BACKGROUND OF THE INVENTION

1. Field of the Invention

The present invention relates generally to materials for use in paving and road construction. More specifically, the present invention relates to a non-tracking, adhesive tack coat for use between layers of pavement, between layers of asphalt, or other asphaltic materials, or for providing a fog seal, and methods of making and applying the same.

2. Description of Related Art

In the construction of new roads, it is often necessary to prepare a base layer, followed by subsequent provision of successive layers of whatever material is selected for the road, which shall be referred to as paving material. In addition, during the repair of roads, layers of cracked, damaged, or otherwise inadequate paving material are removed through grinding or stripping, leaving an exposed underlying layer. As with the construction of new roads, subsequent layers of paving material are then provided to the underlying base layer of a repaired road.

In either of the above situations, it is desirable, and even required, to provide adequate adhesion between the layers of paving material, to reduce slipping and cracking of layers during the life of the road. Inadequate adhesion between layers of paving material can result in cracking, deterioration, and, ultimately, failure of a road. Such results can be dangerous for vehicles passing over such a road. Moreover, such road failures require repairs, resulting in a need to spend additional time and money, a need to detour traffic, and decreased productivity and quality of life for residents of the area of concern.

Adhesives for bonding layers of paving material together are known in the art, and have differing characteristics in terms of composition and ultimate physical properties. The typical adhesive is an asphalt emulsion including asphalt or asphalt by-products, an emulsifier, and water, as well as one or more additives. Typically, these adhesives are known as tack coats.

In many instances, the base layer acts as a rudimentary path for construction vehicles that may utilize the base layer as a temporary road, before subsequent layers of paving material are added and the road is completed. In such situations, the vehicular traffic is travelling on the tack coat, which is applied after a layer of paving material. In such situations, the tack coat will adhere, in part, to the tires of the passing vehicles. This adhesion to tires results in removal of the tack coat from the underlying layer of paving material, reducing the efficacy of the tack coat in providing adhesion between the underlying layer and the subsequently added layer of paving material. Inadequate adhesion can, as described above, result in poor quality, dangerous roads that require subsequent repair. In addition, the tack coat that is adhered to the tires of passing vehicles will then be deposited elsewhere, often in undesirable locations. As such, it is desirable to have a tack coat that is non-tracking, one that will not adhere to the tires of passing vehicles. However, many purported non-tracking tack coats are expensive or ineffective, either in their adhesion quality or their non-tracking quality. Accordingly, there is a need in the art for a quality, non-tracking tack coat.

### SUMMARY OF THE INVENTION

Provided herein is an asphalt emulsion for bonding layers. The emulsion includes asphalt, an acrylic, an emulsifier, and water, and is configured to provide a hardened layer of acrylic superficial to the asphalt, emulsifier, and water when cured. The asphalt used in the emulsion may have a penetration value between about 45 dmm and about 55 dmm. The resultant emulsion may have a penetration value between about 40 dmm and about 60 dmm. In non-limiting embodiments, the resultant emulsion may have a penetration value between about 45 dmm and about 55 dmm.

In non-limiting embodiments, the emulsion further includes a pH adjustor provided in the soap.

In non-limiting embodiments, the asphalt of the emulsion is a mixture of at least two different asphalts forming a blended asphalt.

In some non-limiting embodiments, the emulsion is for use with cationic systems. In such embodiments, the pH adjustor is an acid. In non-limiting embodiments, the acid is hydrochloric acid.

In some non-limiting embodiments, the emulsion is for use with anionic systems. In such embodiments, the pH adjustor is a base. In non-limiting embodiments, the base is potassium hydroxide or sodium hydroxide.

In non-limiting embodiments, the emulsion includes, by weight, between about 40% and about 60% asphalt, between about 1% and about 10% acrylic, between about 0.1% and about 3% emulsifier, between about 0% and about 0.5% pH adjustor. In further non-limiting embodiments, the emulsion includes, by weight, between about 45% and about 55% asphalt, between about 1% and about 5% acrylic, between about 0.5% and about 2% emulsifier, between about 0.1% and about 0.3% pH adjustor.

In non-limiting embodiments, the emulsion further includes a stabilizer. In non-limiting embodiments, the stabilizer is a polysaccharide or a cellulose. In certain non-limiting embodiments, the emulsion includes, by weight, between about 0% and about 0.5% stabilizer.

In non-limiting embodiments, the emulsion has a penetration value of about 40 to about 60 dmm when cured. In further non-limiting embodiments, the emulsion has a penetration value of about 45 dmm to about 55 dmm when cured. In further non-limiting embodiments, the emulsion is non-tracking.

Also provided herein is a method of producing an asphalt emulsion for bonding layers. The method includes heating asphalt, emulsifier, and water to form a soap, mixing the heated asphalt and soap, and adding acrylic to the asphalt and soap mixture to form an emulsion. The emulsion produced by this method is configured to provide a hardened layer of acrylic superficial to the asphalt, emulsifier, and water when the emulsion is dried. In non-limiting embodiments, the acrylic is added to the emulsion immediately after the mixing step.

In non-limiting embodiments, the emulsion includes a pH adjustor in the soap.

In further non-limiting embodiments, a stabilizer is added to the emulsion. The stabilizer may be one of polysaccharides, gums, swellable acrylics (pH activated) and celluloses. In certain non-limiting embodiments, the emulsion includes, by weight, between about 0% and about 0.5% stabilizer.

In non-limiting embodiments, the asphalt is heated to a temperature of at least about 250 degrees Fahrenheit. In non-limiting embodiments, the pH adjustor, emulsifier, and water are heated to a temperature of at least about 75 degrees Fahrenheit.

In non-limiting embodiments, the emulsion that is produced includes, by weight, between about 40% and about 60% asphalt, between about 0.5% and about 10% acrylic, between about 0.1% and about 3% emulsifier, between about 0% and about 0.5% pH adjustor, and water up to 100%. In non-limiting embodiments, the asphalt has a penetration value of between about 45 dmm and about 55 dmm. In non-limiting embodiments, the asphalt is a mixture of at least two different asphalts forming a blended asphalt. Each of the different asphalts has a different penetration value, and the blended asphalt has a penetration value between about 45 dmm and about 55 dmm.

In non-limiting embodiments, the pH adjustor is an acid. In other non-limiting embodiments, the pH adjustor is a base.

In non-limiting embodiments, the emulsion has a penetration value of about 40 to about 60 dmm when cured. In further non-limiting embodiments, the emulsion has a penetration value of about 45 dmm to about 55 dmm when cured. In further non-limiting embodiments, the emulsion is non-tracking.

In non-limiting embodiments of the method of producing a tack coat, the method includes heating the asphalt in a first tank, heating the emulsifier, pH adjustor, and water in a second tank to form the soap, adding the soap to the asphalt to form an emulsion, and milling the emulsion. The emulsion is then deposited into a third tank, and the acrylic is added to form a tack coat.

Also provided herein is a method of producing an asphalt emulsion, including the steps of combining an asphalt, an emulsifier, and water to form an asphalt emulsion and adding acrylic to the asphalt emulsion to form a non-tracking tack coat. The tack coat is configured to provide a hardened layer of acrylic superficial to the asphalt, emulsifier and water when the tack coat is dried.

Also provided herein is a method of bonding a layer of asphalt to a substrate layer. The method includes applying a layer of tack coat to the substrate layer. The tack coat includes a pH adjustor, an acrylic, an emulsifier, and water. The tack coat is configured to provide a hardened layer of acrylic superficial to the asphalt, emulsifier, and water of the tack coat upon application of the tack coat to the substrate layer and curing. The method further includes allowing the tack coat to dry and applying a layer of heated asphalt to the tack coat layer. The heated asphalt softens the tack coat layer and the softened tack coat layer forms a bond between the substrate layer and the asphalt layer.

In non-limiting embodiments, the tack coat used in the method has a penetration value of at least 40 dmm when cured. In non-limiting embodiments, the tack coat is non-tracking. In further non-limiting embodiments, the tack coat is cured for at least 30 minutes.

Also provided herein is a method of providing a fog seal to a remediated surface. The method includes applying a layer of fog seal to the surface. The fog seal includes asphalt, an acrylic, an emulsifier, and water, and is configured to provide a hardened layer of acrylic superficial to the asphalt, emulsifier, and water of the fog seal upon application of the fog seal to the surface and curing.

In non-limiting embodiments, the fog seal that is used has a penetration value of at least 40 dmm when cured. In non-limiting embodiments, the fog seal is formed by diluting a tack coat.

In non-limiting embodiments, the tack coat is formed by heating asphalt, heating a pH adjustor, emulsifier, and water to form a soap, mixing the heated asphalt and soap, and adding acrylic to the asphalt and soap mixture to form a tack coat. The tack coat may then be diluted to an acceptable concentration to form a fog seal.

### BRIEF DESCRIPTION OF THE DRAWINGS

FIG. 1 shows a plan of the method of making a tack coat according to one non-limiting embodiment of the present invention.

### DESCRIPTION OF THE INVENTION

The following description is merely exemplary in nature and is in no way intended to limit the invention, its application, or uses. While the description is designed to permit one of ordinary skill in the art to make and use the invention, and specific examples are provided to that end, they should in no way be considered limiting. It will be apparent to one of ordinary skill in the art that various modifications to the following will fall within the scope of the appended claims. The present invention should not be considered limited to the presently disclosed embodiments, whether provided in the examples or elsewhere herein.

As used herein, the term asphalt refers to any asphaltic-based paving material that can be utilized to construct roads. Such materials include asphalt, asphalt binders, cements, asphalt-based cements, asphalt concrete, cut-back asphalts, emulsified asphalts, and the like. One of ordinary skill in the art will understand that the present invention may be used as an adhesive to bond together layers of any asphaltic material.

Asphalt has various properties, including penetration, or pen value, viscosity, including on asphalt cement and aged residue, and performance grading. As used herein, penetration value refers to the depth into a section of asphaltic material that a needle with a 100 g weight thereon will penetrate when applied to the material for 5 seconds at an ambient temperature of 25 degrees Celsius (77 degrees Fahrenheit). The penetration value is measured in tenths of a millimeter. Thus, an asphalt having a penetration value of 50 dmm is one in which a 100 g weight penetrates the material to a depth of 5 mm after 5 seconds at an ambient temperature of 25 degrees Celsius. Penetration values may be tested according to the AASHTO T-49 standard, developed by the American Society for Testing and Materials, and promulgated by the American Association of State Highway and Transportation Officials.

As used herein, the term tack coat refers to an emulsion containing, at a minimum, asphalt, an emulsifier, and water. Other additives may be added to the emulsion during, before, or after milling that is utilized between layers of a paving material to adhere the layers of paving material together. The tack coat according to the present invention can be used as a non-penetrating prime coat or a fog seal.

As used herein, a fog seal is a layer of an emulsion applied to an oxidized pavement surface that is used to maintain, restore, or rejuvenate a road formed of a paving material.

The use of numerical values in the various ranges specified in this application, unless expressly indicated otherwise, are stated as approximations as though the minimum and maximum values within the stated ranges are both preceded by the word “about”. In this manner, slight variations above and below the stated ranges can be used to achieve substantially the same results as values within the ranges. Also, unless indicated otherwise, the disclosure of these ranges is intended as a continuous range including every value between the minimum and maximum values. For definitions provided herein, those definitions refer to word forms, cognates and grammatical variants of those words or phrases.

As used herein, the terms “comprising,” “comprise” or “comprised,” and variations thereof, are meant to be open ended. The terms “a” and “an” are intended to refer to one or more. An object of the present invention is to provide a tack coat comprising asphalt, an acrylic, a pH adjustor, an emulsifier, and water. Another object of the present invention is to provide a method of making a tack coat comprising the previously-identified components. In a non-limiting embodiment, the tack coat is prepared according to the following method.

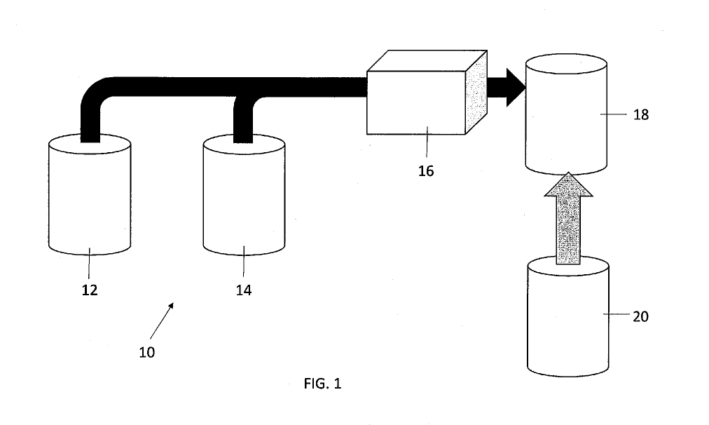

Any asphalt can be used in the present invention. With reference to FIG. 1, in a non-limiting embodiment, asphalt having a penetration value of between about 45 and about 55 dmm is heated in one or more tanks 12 of a system 10 to a temperature of at least 250 degrees Fahrenheit. The asphalt may be produced by mixing asphalts having different penetration values to arrive at an asphalt having a penetration value of between about 45 and about 55 dmm, or may be provided from a manufacturer with a pen value of between about 45 dmm and about 55 dmm. The asphalt or asphalt by-products have a grade denoted by PG XX-YY, wherein XX is the average seven-day maximum pavement design temperature and the YY is the minimum pavement design temperature.

In non-limiting embodiments, the asphalt has a penetration value of between about 45 and about 52 dmm, and is heated to a temperature of at least 260 degrees Fahrenheit, at least 270 degrees Fahrenheit, or at least 280 degrees Fahrenheit. In a preferred, non-limiting embodiment, the asphalt has a penetration value of 48 and is heated to a temperature of at least about 290 degrees Fahrenheit. In a preferred, non-limiting embodiment, the asphalt has a grade of PG 70-22. In non-limiting embodiments, the asphalt comprises between about 40 and about 60% by weight of the tack coat. In a preferred, non-limiting embodiment, the asphalt comprises between about 50 and about 55% by weight of the tack coat.

With further reference to FIG. 1, in at least one other tank 14 separate and apart from the heated asphalt 12, water, pH adjustor, and emulsifier are stored and may be heated. While FIG. 1 shows an embodiment in which water, pH adjustor, and emulsifier are stored in a single tank 14, those of ordinary skill in the art will appreciate that the invention is not so limited, and that the components may be stored in any number of tanks. For example, and without limitation, water, pH adjustor, and emulsifier may be stored in two or more separate tanks and may be added to the emulsion in any way known to those of ordinary skill in the art. In non-limiting embodiments, the water may be supplied directly from a public source.

Again referencing FIG. 1, in a non-limiting embodiment, the water, pH adjustor, and emulsifier are provided in a single tank (all of emulsifier, pH adjustor, and water stored in a single tank and heated to a desired temperature). The mixture may be heated to a temperature of at least about 75 degrees Fahrenheit. This mixture of water, pH adjustor, and emulsifier is referred to as the soap. In some embodiments, the heating can be provided by addition of warm water to the pH adjustor and emulsifier. The pH adjustor is required because the emulsifier will not function to maintain the emulsion without breaking unless the emulsion is maintained at the proper pH. Proper pH for the soap in a cationic system is between about 1 and about 4, and for an anionic system is between about 10 and about 12. In non-limiting embodiments, the system is a cationic system and the pH is between 2 and 3. In non-limiting embodiments, the system is an anionic system and the pH is about 11. Addition of the asphalt to the soap will alter the pH slightly; however, this alteration is not significant.

In non-limiting embodiments, the pH adjustor is an acid or a base, depending on the type of tack coat, cationic or anionic, that is to be produced. In a preferred, non-limiting embodiment, the tack coat is cationic and the pH adjustor is an acid. The acid may be hydrochloric acid. In a preferred, non-limiting embodiment, the tack coat is anionic and the pH adjustor is a base. The base may be sodium hydroxide or potassium hydroxide. In non-limiting embodiments, the pH adjustor is between 0 and about 0.5% by weight of the tack coat. In a preferred, non-limiting embodiment, the pH adjustor is between about 0.2% and about 0.3% by weight of the tack coat.

The emulsifier utilized in the soap is one that is sufficient to prevent breaking of the tack coat emulsion. These emulsifiers may be composed of alkyl amine or salts of an alkyl amine, water, sodium chloride or other acceptable salts known to those of ordinary skill in the art, acid, and amine. In some embodiments, the emulsifier is a rapid-set emulsifier. In some embodiments, the emulsifier has between about 50% and about 100% fatty amine derivatives. In some embodiments, the emulsifier includes greater than about 60%, greater than about 70%, greater than about 80%, greater than about 90%, or up to 100% fatty amine derivatives. In some embodiments, the emulsifier can also include an alcohol, for example and without limitation, methanol, to lower viscosity of the emulsifier. In certain embodiments, the emulsifier includes between about 5% and about 30% methanol. In some embodiments, the emulsifier includes between about 10% and about 30% methanol. In other embodiments, the emulsifier is heated to reduce viscosity. The emulsifier can be heated to a temperature of about 80 degrees Fahrenheit to about 130 degrees Fahrenheit to lower viscosity. In a preferred embodiment, the emulsifier is heated to a temperature of about 120 degrees Fahrenheit.

In embodiments, the emulsifier has a pH of between about 7 and about 12. In other non-limiting embodiments, an emulsifier suitable for use in the present invention includes between about 20% and about 40% by weight alkyl amine or salt of alkyl amine, between about 50% and about 60% by weight water, between about 5% and about 10% by weight sodium chloride or other acceptable salt, between about 2% and about 10% by weight acid, and between about 2% and about 10% by weight amine. Suitable emulsifiers can be purchased commercially from any suitable supplier, for example and without limitation AkzoNobel Chemicals (Pasadena, Calif.), MeadWestvaco (Richmond, Va.), Kao Chemicals (High Point, N.C.), and ArrMaz/Road Science (Mulberry, Fla.).

In some embodiments, a mixture of rapid-set emulsifiers and traditional, medium-set and slow-set emulsifiers can be used. The percentage of each type of emulsifier used can be adjusted readily by one of ordinary skill in the art.

Desirable properties for an emulsifier for use with the present invention include a pour point between about 5 and about 15 degrees Celsius, a flash point higher than about 75 degrees Celsius, a viscosity of between about 20 and about 50 cP, and a density of between about 7 and about 10 pounds per gallon. In non-limiting embodiments, the emulsifier is between about 0.1 and about 3% by weight of the tack coat, or between about 1 and about 2% by weight of the tack coat. In a preferred, non-limiting embodiment, the emulsifier is a slow set emulsifier and is between about 1.25% and about 1.75% by weight of the tack coat. In another non-limiting embodiment, the emulsifier is a rapid-set emulsifier and is between about 0.2% and 0.4% by weight of the tack coat.

In certain embodiments, in addition to the emulsifier, asphalt additives can be included with the present invention. These additives can include peptizers/peptizing agents and the like, known to those of skill in the art. These agents act to improve adhesion, reduce the viscosity of the asphalt, reduce particle size of asphalt in the emulsion, increase emulsion quality, and increase acrylic compatibility. As used herein, a peptizer/peptizing agent means any additive that can disperse a substance in a colloidal state, or that can reduce viscosity, by depolymerization or dispersion.

In some embodiments, the peptizer/peptizing agent includes between about 50% and about 65% alkoxylated polyamines, between about 5% and about 10% fatty acids, between about 2% and about 10% alkoxylated amines, between about 0% and about 5% fatty polyamines, and between about 25% and about 35% of one or more solvents. In a non-limiting, preferred embodiment, the peptizer/peptizing agent includes 55-60% alkoxylated fatty polyamines, 8-10% fatty acids, 4-7% alkoxylated amines, and 1-3% polyamines, and has a pH of between about 8 and about 13, preferable between about 9 and about 12. Suitable peptizers/peptizing agents can be purchased from any suitable commercial source.

In some embodiments, the asphalt additive is added to the asphalt before the asphalt is emulsified. In embodiments, the asphalt additive is included in the asphalt in a range of between about 0.1 to about 1.5% by weight of the asphalt. In further embodiments, the asphalt additive is included in a range of between about 0.3 to about 0.8% by weight of the asphalt.

In non-limiting embodiments, the soap is heated to a temperature of at least about 85 degrees Fahrenheit, at least about 90 degrees Fahrenheit, or at least about 95 degrees Fahrenheit. In a preferred, non-limiting embodiment, the soap is heated to a temperature of at least about 100 degrees Fahrenheit.

With further reference to FIG. 1, the mixture of the heated asphalt and the soap is prepared by first mixing the soap and asphalt together. As described above, the soap will be at a particular pH range, depending on the type of system (cationic or anionic) that is being employed. Addition of the asphalt to the soap alters the pH, but this alteration is not significant. The composition is milled using a colloid mill or any other suitable type of mill 16 and then deposited in a tank 18 and mixed using any acceptable type of mixer known to those of ordinary skill in the art. In a non-limiting embodiment, the composition is mixed using a cowles mixer. During the milling and mixing process, the composition is passed through an expansion header to allow for boiling and evaporation of water, as the composition is kept at a temperature of between about 200 and about 330 degrees Fahrenheit during the process and when it is discharged. In a preferred, non-limiting embodiment, the composition is milled, mixed, and discharged at a temperature of between about 300 and about 315 degrees Fahrenheit.

In non-limiting embodiments in which the emulsifier, pH adjustor, and water are stored in separate tanks, the components of the soap may be introduced to the asphalt as the asphalt is being moved to the mill 16. This introduction may occur at once (i.e. the emulsifier, pH adjustor, and water are mixed and then mixed with the asphalt) or separately (i.e. the emulsifier, pH adjustor, and water may be added separately to the asphalt as the asphalt travels to the mill 16, and the combination of soap and asphalt is then milled and mixed.

The composition including the soap and asphalt is mixed and may be stored for up to one month. With continuing reference to FIG. 1, when the composition is ready to be sent out for application to a road surface, the composition is milled or mixed, then the acrylic 20 is added to provide a tack coat. In other, non-limiting embodiments, the composition comprising asphalt and soap is milled immediately after mixing and the acrylic is then added, and the tack coat is stored. In further embodiments, the acrylic can be added to the mixture of soap and asphalt prior to storage in a tank, or may be added to the mixture of soap and asphalt while in a storage tank.

In non-limiting embodiments, the acrylic is a styrene acrylic that can be silicone modified. In non-limiting embodiments, the acrylic is one having between about 40% and about 60% solids and having a viscosity of between about 300 cP and about 500 cP. The acrylic should have a transition temperature (T_{g}) of between about −40 and about 40 degrees Celsius, including sub-ranges therein. In an embodiment, the Tg of the acrylic is between about 5 and about 15 degrees Celsius and a minimum filming temperature of between about 20 and about 40 degrees Celsius. The density of the acrylic should be between about 6 and about 12 pounds per gallon. In a preferred, non-limiting embodiment, the acrylic is about 50% solids, has a viscosity of about 400 cP, a transition temperature of about 10 degrees Celsius, a minimum filming temperature of about 30 degrees Celsius, and a density of about 9 pounds per gallon. In non-limiting embodiments, the acrylic has a pH of between about 6 and about 9. In a preferred, non-limiting embodiment, the acrylic is a product that works with both a cationic tack coat and an anionic tack coat. In non-limiting embodiments, the acrylic is between about 0.5% and about 10% by weight of the tack coat. In a preferred, non-limiting embodiment, the acrylic is more than about 3% by weight of the tack coat. In a further non-limiting embodiment, the acrylic is between about 4% and about 5% by weight of the tack coat. Suitable acrylics can be purchased from commercial sources known to those of ordinary skill in the art, including, without limitation, Synthomer (Atlanta, Ga.), STI Polymer (Sanford, N.C.), BASF (Florham Park, N.J.), Wacker Polymers (Calvert City, Ky.), and Scott Bader (Stow, Ohio).

In such non-limiting embodiments in which the acrylic is added immediately after the asphalt-soap composition is mixed and milled, it is desirable to add a stabilizer to the tack coat to prevent settling during storage. In non-limiting embodiments, the stabilizer added during storage of the tack coat is one or more of polysaccharides, gums, swellable acrylics, and celluloses. In a non-limiting embodiment, the stabilizer is a xyrosic thickener. In non-limiting embodiments, the stabilizer is one or more of Actigum™ CS6, manufactured by Cargill™ (Minneapolis, Minn.), guar gum, and xanthan gum. In a non-limiting embodiment, the stabilizer is ROHAGIT SD 9523, manufactured by Synthomer (Atlanta, Ga.). In a preferred, non-limiting embodiment, the stabilizer is Bermocoll® EM 7000 FQ, manufactured by AkzoNobel Chemicals (Pasadena, Calif.). In certain embodiments, stabilizer is not required. However, in embodiments in which stabilizer is utilized, the stabilizer can be present in an amount of 0.1% to about 0.5% by weight of the tack coat.

The tack coat formed from the above-identified materials has a penetration value of greater than 40 dmm. In non-limiting embodiments, the tack coat has a penetration value of greater than 41 dmm and less than 60 dmm. In a preferred, non-limiting embodiment, the tack coat has a penetration value of greater than 45 dmm. In non-limiting embodiments, the tack coat has a softening point of between about 40 and about 60 degrees Celsius. In a non-limiting embodiment, the track coat is substantially non-tracking. In a preferred, non-limiting embodiment, the tack coat is non-tracking.

The tack coat formed from the above-identified materials in the above-identified manner may be utilized as an adhesive for bonding together layers of paving material. For example, a base layer is provided, and a layer of non-tracking tack coat is applied to that base layer through known means, for example and without limitation a distributor or pressurized sprayer, and allowed to dry, or cure. The tack coat may be applied at any suitable rate or amount. Typically, the tack coat according to the present invention is applied at between 0.01 and 0.15 gallons per square yard (gpy). In non-limiting embodiments, the tack coat is applied at between 0.04 and 0.08 gpy. In a preferred, non-limiting embodiment, the tack coat is applied at 0.05 gpy. Those of ordinary skill will understand that a lesser amount of tack coat can be applied when the tack coat is applied to fresh asphalt, and a greater amount will be required for milled surfaces.

Additionally, depending on the use of the tack coat, the amount applied can be adjusted as known to those of skill in the art. For example and without limitation, if the tack coat is to be used as a non-penetrating prime coat, it can be applied at 0.25 gpy. If the tack coat is diluted and utilized as a fog seal (as described below), it can be applied at between 0.05 and 0.15 gpy.

When it is applied, the tack coat is heated to a temperature suitable for even application of the composition. In non-limiting embodiments, the tack coat should be between about 100 and about 200 degrees Fahrenheit when it is applied. In preferred non-limiting embodiments, the tack coat is applied at between 140 and 180 degrees Fahrenheit. Drying or curing typically occurs between about 10-60 minutes, or between about 15-30 minutes, depending on the environmental conditions (temperature, direct light/sun, humidity, airflow), application rate, application temperature, and the like. The makeup of the tack coat, the particular materials utilized in the emulsion in the specified ranges, allows for the acrylic to form a hardened layer superficial to the remainder of the materials in the emulsion (water, asphalt, pH adjustor, emulsifier, and stabilizer, if any) during drying or curing.

Once the tack coat is applied to the base layer and allowed to dry or cure, another layer of paving material is provided on top of the tack coat layer. As provided above, the tack should be permitted to cure for 15-30 minutes, but could take from between 10-60 minutes to cure. The tack coat according to the present invention provides adequate bonding in cold paving, as well as with warm and hot-mix asphalts. In non-limiting embodiments, hot-mix asphalt is applied to the tack coat once the tack coat has cured. In such embodiments, the asphalt is at a temperature of between 250 and 350 degrees Fahrenheit when it is applied. The heat from the newly added paving material will re-liquefy the tack coat, and permits a bond to be formed between the base layer and the newly added layer of paving material. This process, provision of a tack coat on top of the paving material, drying/curing of the tack coat, and provision of a hot layer of paving material on top of the tack coat may be repeated as many times as necessary to provide a complete, paved road.

In non-limiting embodiments, a fog seal, used for repairing and rejuvenating roads, is applied to a road surface. The tack coat described above may be further diluted to produce the fog seal. For example, when used as a fog seal, the tack coat would be diluted by adding up to 20% water, resulting in a composition having an asphalt residue percentage of about 40%. The fog seal can be applied to a road surface that is in need of repair and remediation, or to a remediated road surface.

### EXAMPLES

### Example 1

A tack coat was prepared with the elements in the amounts provided in Table 1, below.

TABLE 1

| | | Amount Used | | | | |
|---|---|---|---|---|---|---|
| Product | | Lbs | Gal | % BW | LB/Gal | |
| Hydrochloric | | 48 | 5.0 | 0.27 | 9.67 | |
| Acid | | | | | | |
| Emulsifier | | 271 | 33.0 | 1.51 | 8.20 | |
| Acrylic | | 722 | 83 | 4.04 | 8.70 | |
| Total Soap | | | 1000 | | | |
| Asphalt (48 | | 9020 | 1055 | | | |
| Pen) | | | | | | |
| Total tack | 2138 | | 17876 | | 52.5 | Calc % |
| coat produced | gal | | lbs | | | total |
| | | | | | | residue |
| | | | | | 50.5 | Calc % |
| | | | | | | asphalt |

As provided in the above table, the final tack coat contained 52.5% residue and 50.5% asphalt. Acceptable ranges for both are from about 50% to about 60% (total residue) and from about 50% to about 60% (asphalt). In certain embodiments, the tack coat includes a percent residual content (total residue) of greater than about 50%, greater than about 60%, or greater than about 65%. In preferred, non-limiting embodiments, the percent residue in the tack coat is between about 50% and about 65%, and the percent asphalt is between about 50% and about 53%. In other non-limiting embodiments, the percent residue in the tack coat is between about 50% and about 55%.

Parameters for the tack coat, and the testing method by which they may be determined, are provided in Table 2, below.

TABLE 2

| Parameter | Test Method | Min. | Max. |
|---|---|---|---|
| Sieve (%) | AASHTO T-59 | 0.01 | 0.06 |
| Open Evaporation | AASHTO T-59 | 50 | 60 |
| Penetration | AASHTO T-49 | 40 | 60 |
| Viscosity (Saybolt Furol) | AASHTO T-59 | 10 | 50 |
| @ 77 degrees Fahrenheit | | | |

In a preferred embodiment, the parameters for the tack coat, and the testing method by which they may be determined, are provided in Table 3, below.

TABLE 3

| Parameter | Test Method | Min. | Max. |
|---|---|---|---|
| Sieve (%) | AASHTO T-59 | 0.00 | 0.1 |
| Sieve (Field Sample) | AASHTO T-59 | 0.00 | 0.4 |
| Open Evaporation | AASHTO T-59 | 50 | 60 |
| Residue (%) | AASHTO T-59 | 50 | |
| Penetration | AASHTO T-49 | 40 | 60 |
| Softening Point (ring and ball, ° C.) | AASHTO T-53 | 40 | 60 |
| Viscosity (Saybolt Furol) | AASHTO T-72 | 10 | 50 |

Additional batches of tack coat were prepared in accordance with the above-identified materials, producing tack coats as provided in the following examples:

### Example 2

| | |
|---|---|
| Asphalt | PG 70-22 (48-52 dmm); 56% |
| Soap | 12 gallons of acid; 82 gallons of emulsifier; |
| | pH: 1.65; Total Soap - 2000 gallons |
| Acrylic | 200 gallons, introduced at 10.8 gallons/min |
| Milling Conditions | 180.8 degrees |
| Resultant Tack Coat | Asphalt residue: 56.70%; Pen Value: 45.66 |

### Example 3

| | |
|---|---|
| Asphalt | PG 70-22 (48-52 dmm); 62.02% |
| Soap | 40 gallons of acid; 292 gallons of emulsifier; |
| | Total Soap - 6000 gallons |
| Acrylic | 660 gallons, introduced at 10.3 gallons/min |
| Milling Conditions | 183 degrees |
| Resultant Tack Coat | Pen Value: 49.33 |

### Example 4

| | |
|---|---|
| Asphalt | PG 70-22 (48-52 dmm); 54.76% |
| Soap | 23 gallons of acid; 184 gallons of emulsifier; |
| | pH: 1.75; Total Soap - 4500 gallons |
| Acrylic | 445 gallons, introduced at 10.2 gallons/min |
| Milling Conditions | 176 degrees |
| Resultant Tack Coat | Asphalt residue: 53.62%; Pen Value: 46 |

### Example 5

| | |
|---|---|
| Asphalt | PG 70-22 (48-52 dmm); 55.08% |
| Soap | 23 gallons of acid; 184 gallons of emulsifier; |
| | pH: 1.75; Total Soap - 4500 gallons |
| Acrylic | 445 gallons, introduced at 5.0 gallons/min |
| Milling Conditions | 177.2 degrees |
| Resultant Tack Coat | Asphalt residue: 53.62%; Pen Value: 48 |

### Example 6

| | |
|---|---|
| Asphalt | PG 70-22 (48-52 dmm); 54.14% |
| Soap | 23 gallons of acid; 184 gallons of emulsifier; |
| | pH: 1.75; Total Soap - 4500 gallons |
| Acrylic | 445 gallons, introduced at 10.2 gallons/min |
| Milling Conditions | 176.4 degrees |
| Resultant Tack Coat | Asphalt residue: 53.62%; Pen Value: 51 |

As a control, a tack coat prepared from asphalt having a lower (harder) penetration value than that called for in the present invention was produced, as follows:

### Example 7

| | |
|---|---|
| Asphalt | PG 70-22 (30 dmm mixed with softer |
| | asphalt); 51.96% |
| Soap | 23 gallons of acid; 151 gallons of emulsifier; |
| | pH: 2.0; Total Soap - 5000 gallons |
| Acrylic | 470 gallons, introduced at 8.8 gallons/min |
| Milling Conditions | 174.7 degrees |
| Resultant Tack Coat | Asphalt residue: 51.45%; Pen Value: 37 |

Rather than asphalt having a penetration value of between about 45 and about 55 dmm, asphalt having a penetration value of 30 dmm was utilized in forming the emulsion. The resultant tack coat had a penetration value of 37 dmm, and was too hard to be utilized.

While the present invention has been described in terms of the above examples and detailed description, those of ordinary skill will understand that alterations may be made within the spirit of the invention. Accordingly, the above should not be considered limiting, and the scope of the invention is defined by the appended claims.

1. An asphalt emulsion for bonding layers comprising asphalt, an acrylic, an emulsifier, and water, wherein the emulsion is configured to provide a hardened layer of acrylic superficial to the asphalt, emulsifier, and water when cured.

2. The asphalt emulsion according to claim 1, wherein the asphalt has a penetration value of between about 45 dmm and about 55 dmm.

3. The asphalt emulsion according to claim 1, wherein the asphalt is a mixture of at least two different asphalts forming a blended asphalt, each of the different asphalts having a different penetration value, wherein the blended asphalt has a penetration value between about 45 dmm and about 55 dmm.

4. The asphalt emulsion according to claim 1, further comprising a pH adjustor, and wherein the pH adjustor is an acid.

5. The asphalt emulsion according to claim 4, wherein the acid is hydrochloric acid.

6. The asphalt emulsion according to claim 1, further comprising a pH adjustor, and wherein the pH adjustor is sodium hydroxide or potassium hydroxide.

7. The asphalt emulsion according to claim 1, wherein the emulsion comprises, by weight, between about 40% and about 60% asphalt, between about 1% and about 10% acrylic, and between about 0.1% and about 3% emulsifier.

8. The asphalt emulsion according to claim 1 wherein the emulsion comprises, by weight, between about 45% and about 55% asphalt, between about 1% and about 5% acrylic, and between about 0.5% and about 2% emulsifier.

9. The asphalt emulsion according to claim 1, wherein the emulsion has a penetration value of about 40 to about 60 dmm when cured.

10. The asphalt emulsion according to claim 9, wherein the emulsion has a penetration value of about 45 dmm to about 55 dmm when cured.

11. The asphalt emulsion according to claim 1, wherein the emulsion is non-tracking.

12. A method of producing a tack coat for bonding pavement layers comprising: combining an asphalt, an emulsifier, and water to form an asphalt emulsion; and
adding acrylic to the asphalt emulsion to form a non-tracking tack coat, wherein the tack coat is configured to provide a hardened layer of acrylic superficial to the asphalt, emulsifier, and water when the tack coat is dried.

13. The method according to claim 12, further comprising heating the asphalt to a temperature of at least about 250 degrees Fahrenheit heating and the emulsifier and water to a temperature of at least about 75 degrees Fahrenheit.

14. The method according to claim 12, wherein the non-tracking tack coat comprises, by weight, between about 40% and about 60% asphalt, between about 1% and about 10% acrylic, between about 0.1% and about 3% emulsifier, and water up to 100%.

15. The method according to claim 12, wherein the asphalt has a penetration value of between about 45 dmm and about 55 dmm.

16. The method according to claim 12, wherein the asphalt is a mixture of at least two different asphalts forming a blended asphalt, each of the different asphalts having a different penetration value, wherein the blended asphalt has a penetration value between about 45 dmm and about 55 dmm.

17. The method according to claim 12, further comprising a pH adjustor in the asphalt emulsion, wherein the pH adjustor is an acid.

18. The method according to claim 12, further comprising a pH adjustor in the asphalt emulsion, wherein the pH adjustor is a base.

19. The method according to claim 12, wherein the non-tracking tack coat has a penetration value of 40 to 60 dmm when cured.

20. The method according to claim 19, wherein the non-tracking tack coat has a penetration value of 45 to 55 dmm when cured.

21. A method of bonding a layer of asphalt to a substrate layer comprising:
applying to the substrate layer a layer of a tack coat comprising asphalt, an acrylic, an emulsifier, and water, wherein the tack coat is configured to provide a hardened layer of acrylic superficial to the asphalt, emulsifier, and water of the tack coat upon application of the tack coat to the substrate layer and curing of the tack coat;
allowing the tack coat to cure;
hardening the acrylic thereby forming the hardened acrylic layer; and
applying a layer of heated asphalt to the tack coat layer, wherein the heated asphalt softens the tack coat layer and the softened tack coat layer forms a bond between the substrate layer and the asphalt layer.

22. The method according to claim 21, wherein the tack coat has a penetration value of at least 40 dmm when cured.

23. The method according to claim 21, wherein the tack coat is non-tracking.

24. A method of providing a fog seal to a remediated surface, comprising applying to the surface a layer of a fog seal comprising asphalt, an acrylic, an emulsifier, and water, wherein the fog seal is configured to provide a hardened layer of acrylic superficial to the asphalt, emulsifier, and water of the fog seal upon application of the fog seal to the surface curing of the fog seal; and hardening the acrylic thereby forming the hardened layer of acrylic.
